(19) United States
(12) Patent Application Publication
(10) Pub. No.: US 2011/0205467 A1
(43) Pub. Date: Aug. 25, 2011

(54) LIQUID CRYSTAL DISPLAY DEVICE AND METHOD FOR MANUFACTURING SAME

(75) Inventor: Eiji Satoh, Osaka (JP)

(73) Assignee: SHARP KABUSHIKI KAISHA, Osaka (JP)

(21) Appl. No.: 13/122,728

(22) PCT Filed: Oct. 13, 2009
(86) PCT No.: PCT/JP2009/005319

§ 371 Date: Apr. 5, 2011

(30) Foreign Application Priority Data
Oct. 15, 2008 (JP) 2008-266620

(51) Int. Cl. G02F 1/1334; G02F 1/1337; H01J 9/00

(52) U.S. Cl. 349/94; 445/24

(57) ABSTRACT

A liquid crystal display device 100 includes a liquid crystal layer 1 including polymer; a front substrate 3 and a rear substrate 2 containing the liquid crystal layer 1 therebetween; a pair of electrodes 4 and 8 applying a voltage on the liquid crystal layer 1; polarization plates 16 and 15 placed respectively on the front side of the front substrate 3 and the rear side of the rear substrate 2; and first and second alignment films 13 and 12 formed respectively between the liquid crystal layer 1 and the front substrate 3 and between the liquid crystal layer 1 and the rear substrate 2. An alignment treatment is applied to at least one of the alignment films 12 and 13; the liquid crystal layer 1 includes in each of the pixels a plurality of liquid crystal regions 11 and a wall 10 containing polymer located between adjoining liquid crystal regions 11; and the plurality of liquid crystal regions 11 includes two liquid crystal regions in which in-plane orientations of liquid crystal molecules in the two liquid crystal regions at the interface on the side of the alignment film on which the alignment treatment has been applied are both parallel to the direction defined by the alignment treatment, and tile directions of the liquid crystal molecules in the two liquid crystal regions at the interface are mutually different.

### TECHNICAL FIELD

The present invention relates to a liquid crystal display device and a method of manufacturing thereof.

### BACKGROUND ART

Known methods of aligning the liquid crystal include a rubbing method and an optical alignment film method. With the rubbing method, an alignment film, such as polyimide, is coated on a substrate surface, and then the alignment film is rubbed in a prescribed direction (rubbing direction) using, for example, a piece of cloth. When a liquid crystal layer is formed on such an alignment film, it is possible to control the in-plane orientation of the liquid crystal molecules to be in parallel with the rubbing direction. Furthermore, with the optical alignment film method, an optical alignment film made of a photosensitive material is coated on a substrate surface, and the optical alignment film is irradiated with polarized UV rays. The liquid crystal molecule orientation is controlled with the direction and angle of irradiation. Furthermore, a technology of controlling the liquid crystal orientation is also known in which a rib structure, for example, is formed on a substrate surface, or an electrode having slits (spacing) is formed on the substrate, and a vertical alignment film is coated atop.

Display modes, such as the ECB (electrically controlled birefringence), TN (twisted nematic), STN (super twisted nematic), VA (vertical alignment), IPS (in plane switching), OCB (optically compensated bend), and HAN (hybrid aligned nematic), have been commercialized using two substrates, on which an alignment treatment such as the aforementioned has been applied, and inserting a liquid crystal or a liquid crystal including a chiral agent therebetween.

When the orientation of liquid crystal molecules is controlled as described above, the liquid crystal molecules in a liquid crystal layer in the TN mode, for example, stand up from a prescribed orientation (pre tilt orientation) and become aligned to be in parallel with the electrical field under a voltage. Because the liquid crystal molecules are optically anisotropic, the display panel displays non-uniform view angle characteristics, depending on the angle from which it is viewed, when the liquid crystal molecules stand up from a specific orientation, as described above. In other words, the display contrast ratio is subject to a problem of non-uniformity across the view angles.

In order to address the above-mentioned problem, a technique is used in which each pixel in the liquid crystal display device is divided into a plurality of regions in which the liquid crystal molecules stand in different orientation directions (orientation division).

In a method called the masked rubbing method, for example, a portion of the alignment film is masked, and the first rubbing is performed, and then the other portion is masked, and the second rubbing is performed in a direction opposite to the first rubbing in order to form two regions. The masked rubbing method, however, requires a plurality of rubbing steps using masks, and the process is complicated.

When the slits or ribs are formed on the substrate surface, the orientation division is possible using the slit and rib structures. However, a complicated orientation control structure needs to be created, and improvements in the view angle characteristics are limited by issues such as the processing precision.

On the other hand, Patent Document 1, for example, proposes four micro regions coexisting in one pixel and having different liquid crystal stand orientations and liquid crystal twist orientations. Patent Document 1 describes that, when a liquid crystal layer held between two substrates is first heated to be in the isotropic phase and then cooled to or less than the phase transition temperature between the liquid crystal phase and the isotropic phase, a large number of liquid crystal droplets are formed from the isotropic phase during this cooling process, and the aforementioned four micro regions are created in roughly equal portions (paragraph [0077] in Patent Document 1). Furthermore, there is a description on a small amount of polymer in the liquid crystal stabilizing these micro regions.

Furthermore, Patent Document 2 proposes using a polymer dispersed liquid crystal to form in a single pixel a plurality of regions (for example, region A and region B) having different liquid crystal twist orientations and/or twist angles. According to the method of manufacturing the liquid crystal display device described in Patent Document 2, a solution containing the liquid crystal and a polymer precursor is held between the substrates, and the regions A and B within the pixel are irradiated with polarized light beams having mutually different polarization axes to optically polymerize the polymer precursor. According to Patent Document 2, the liquid crystal and polymer in the regions A and B can be made to align along the respective optical axes of the polarized radiation light using the aforementioned method.

The methods described above allow each pixel to be divided into a plurality of regions having different orientations. As a result, the display contrast ratio becomes less dependent on the view angles because the viewer sees an average of the various regions.

### PRIOR ART DOCUMENTS

### Patent Documents

Patent Document 1: Japanese Patent Application Laid-Open Publication No. H9-152608

Patent Document 2: Japanese Patent Application Laid-Open Publication No. H9-138412

### SUMMARY OF THE INVENTION

### Problems to be Solved by the Invention

In the method of forming the liquid crystal layer described in Patent Document 1, four micro regions having different orientations are formed by taking advantage of the cooling process for the liquid crystal solution. However, it is difficult to precisely control the temperature of the liquid crystal layer and reliably form four micro crystal regions in each pixel using this method. In particular, it is extremely difficult to control the temperature uniformly across the surface of the liquid crystal layer when the substrate size exceeds tens of centimeters on each side. As a result, the display may become non-uniform across the surface. Furthermore, it is difficult to manufacture a display device with superior view angle characteristics in a stable manner.

The method described in Patent Document 2 relies on a mechanism in which the directions of polarization of the polarized UV rays dictate the orientations of the liquid crystal molecules. More specifically, when the angle between the direction of polarization and the rubbing direction is set at less than 90°, the liquid crystal molecules would show a twist which starts in a direction parallel to the rubbing direction and ends in a direction corresponding to the smaller of the angular differences formed with respect to the direction of polarization. For this reason, it is not possible to set the angle of the twist at near 90° or to implement the TN mode with a 90° twist using the polarization plates. Furthermore, the division into the plurality of regions having different twist directions (regions A and B) requires irradiation of the polarized UV rays over multiple times using masks. Furthermore, the masks must be aligned, and a misalignment may degrade the display characteristics. Furthermore, irradiation of highly collimated polarized UV rays contributes to the problem of added manufacturing costs. Moreover, as mentioned earlier, the liquid crystal would not get twisted in a region in which the polymer precursor having the liquid crystal properties has been cured along the direction of polarization of the polarized UV ray, because the liquid crystal is aligned along the direction of polarization of the polarized UV ray. For this reason, it is difficult to achieve uniform twisting across the thickness of the liquid crystal layer.

The present invention has been made in consideration of the issues described above. A main object of the present invention is to provide a liquid crystal display device with superior view angle characteristics using a more simple process.

### Means for Solving the Problems

A liquid crystal display device of the present invention includes a plurality of pixels; a liquid crystal layer containing polymer; a front substrate and a rear substrate holding the aforementioned liquid crystal layer therebetween; a pair of electrodes laid out with the aforementioned liquid crystal layer sandwiched therebetween for applying a voltage on the aforementioned liquid crystal layer; polarizing plates placed on the front side of the aforementioned front substrate and the rear side of the aforementioned rear substrate, respectively; first and second alignment films formed, respectively, between the aforementioned liquid crystal layer and the aforementioned front substrate and between the aforementioned liquid crystal layer and the aforementioned rear substrate. An alignment treatment has been applied on at least one of the aforementioned first and second alignment films; the aforementioned liquid crystal layer includes in each of the aforementioned pixels a plurality of liquid crystal regions and a wall including the aforementioned polymer positioned between adjacent liquid crystal regions; and the aforementioned plurality of liquid crystal regions includes two liquid crystal regions in which the in-plane orientations of the liquid crystal molecules at the interface on the side of the alignment film on which the aforementioned alignment treatment has been applied are in parallel with the direction defined by the aforementioned alignment treatment, and the tilt directions of the liquid crystal molecules at the aforementioned interface are mutually different.

In a preferred embodiment, the aforementioned liquid crystal layer includes a plurality of small chambers isolated by the aforementioned wall, and the aforementioned plurality of liquid crystal regions are respectively formed in one of the aforementioned plurality of small chambers.

The aforementioned two liquid crystal regions may preferably be formed in different small chambers, respectively.

The aforementioned two liquid crystal regions may be formed in one small chamber and are isolated by the aforementioned polymer.

In a preferred embodiment, at least a portion of the aforementioned polymer that dose not constitute the wall is present on the alignment film.

The aforementioned plurality of liquid crystal regions preferably include four liquid crystal regions having mutually different liquid crystal molecule tilt directions at a position corresponding to the center point along the thickness of the aforementioned liquid crystal layer.

The alignment treatment may be applied on both of the aforementioned first and second alignment films, and the direction defined by the aforementioned first alignment film and the direction defined by the aforementioned second alignment film may form an angle of 70 degrees or greater and less than 110 degrees when viewed from a normal direction with respect to the aforementioned front substrate.

The direction defined by the aforementioned alignment treatment may be identical across the entire the aforementioned alignment film.

A manufacturing process for the liquid crystal display device of the present invention includes the step of preparing a front substrate having a surface on which a first alignment film is formed and a rear substrate having a surface on which a second alignment film is formed; the step of applying an alignment treatment on at least one of the aforementioned first and second alignment films; the step of positioning the aforementioned front substrate and the aforementioned rear substrate in such a way that the aforementioned first and second alignment films face each other, and injecting a liquid crystal material and a liquid crystal mixture, containing one or both of monomer or oligomer, between the aforementioned positioned substrates; and the step of obtaining a liquid crystal layer by creating a liquid crystal phase in a process of polymerizing the aforementioned monomer or oligomer or both at a temperature equal to or greater than the transition temperature Tni of the aforementioned liquid crystal mixture. The aforementioned liquid crystal layer includes a plurality of liquid crystal regions including two liquid crystal regions in which the in-plane orientations of the liquid crystal molecules at the interface on the side of the alignment film on which the aforementioned alignment treatment has been applied are in parallel with the direction defined by the aforementioned alignment treatment, and the tilt directions of the liquid crystal molecules at the aforementioned interface are mutually different.

### Effects of the Invention

In a liquid crystal display device of the present invention, two liquid crystal regions are formed in a single pixel to have liquid crystal molecules with the in-plane orientations parallel to each other at the interface between the liquid crystal layer and the alignment film. But the tilt directions of the liquid crystal molecules in the two regions are mutually different. Accordingly, the view angle characteristics are improved, and wider view angle is realized. Furthermore, because a wall containing a polymer is placed between the adjoining liquid crystal regions, the orientation of liquid crystal molecules in each liquid crystal region is stable.

When the two aforementioned liquid crystal regions are formed respectively in separate small chambers isolated by a wall containing polymer, the liquid crystal orientation in each liquid crystal region is made more stable. Furthermore, because the presence of a disclination line at a boundary of these liquid crystal regions is avoided, a display offering a higher contrast ratio than the conventional art is obtained.

The two aforementioned liquid crystal regions may also be formed inside the same small chamber. In such an instance, the orientation in each liquid crystal region is more stable, if the liquid crystal regions are isolated by polymer.

According to the present invention, an effect similar to the orientation division is achieved with a more simple and less costly process, and liquid crystal display devices with superior view angle characteristics are realized without multiple rubbing steps and UV irradiation steps or without forming a complex structure, such as a rib or a slit, in a pixel.

### BRIEF DESCRIPTION OF THE DRAWINGS

FIG. 1(a) is a cross-sectional schematic showing a liquid crystal display device of a preferred embodiment of the present invention, while FIG. 1(b) is a top view schematic showing a portion of a liquid crystal layer in the liquid crystal display device shown in FIG. 1(a).

FIG. 2(a) through FIG. 2(c) are, respectively, a top view diagram, a perspective view diagram, and a cross-sectional view diagram showing the alignments of the liquid crystal molecules located at an interface between a liquid crystal layer and an alignment film in a preferred embodiment of the present invention.

FIG. 3(a) through FIG. 3(c) are, respectively, top view diagrams showing examples of the layouts of liquid crystal regions in preferred embodiments of the present invention.

FIG. 4(a) through FIG. 4(d) are perspective view diagrams schematically showing four types of liquid crystal regions having different orientations.

FIG. 5 is a diagram showing the tilt directions of the liquid crystal molecules positioned at the center points of the four types of liquid crystal regions shown in FIG. 4 on a plane parallel to the liquid crystal layer.

FIG. 6 is a schematic diagram representing the refractive index ellipsoid of the liquid crystal molecules.

FIG. 7 is a perspective view diagram showing the orientation of liquid crystal molecules located at a center portion of the liquid crystal region.

FIG. 8 is a diagram mapping the contrast contour lines of a display panel of Embodiment 1 of the present invention.

FIG. 9 is a diagram mapping the contrast contour lines of a display panel of Embodiment 2 of the present invention.

FIG. 10 is a diagram mapping the contrast contour lines of a display panel of a comparison example for the present invention.

FIG. 11 is a diagram showing the V-T curves of the display panels of Embodiments 1 and 2 and the comparison example of the present invention.

FIG. 12 is a graph showing the calculated results on the optical transmissivity in a display panel using the TN liquid crystal, when the polarization plates are shifted from a cross-Nicol condition to 45° and to −45°.

FIG. 13 is a diagram showing a microscopic image of an experiment-use display cell according to a preferred embodiment 3 of the present invention.

### DETAILED DESCRIPTION OF EMBODIMENTS

Preferred embodiments of the liquid crystal display device of the present invention will be described next with reference to the figures. While examples of liquid crystal display devices of the TN mode will be described, the display mode of the liquid crystal display device of the present embodiments is not limited to the TN mode and may be the HAN mode, for example.

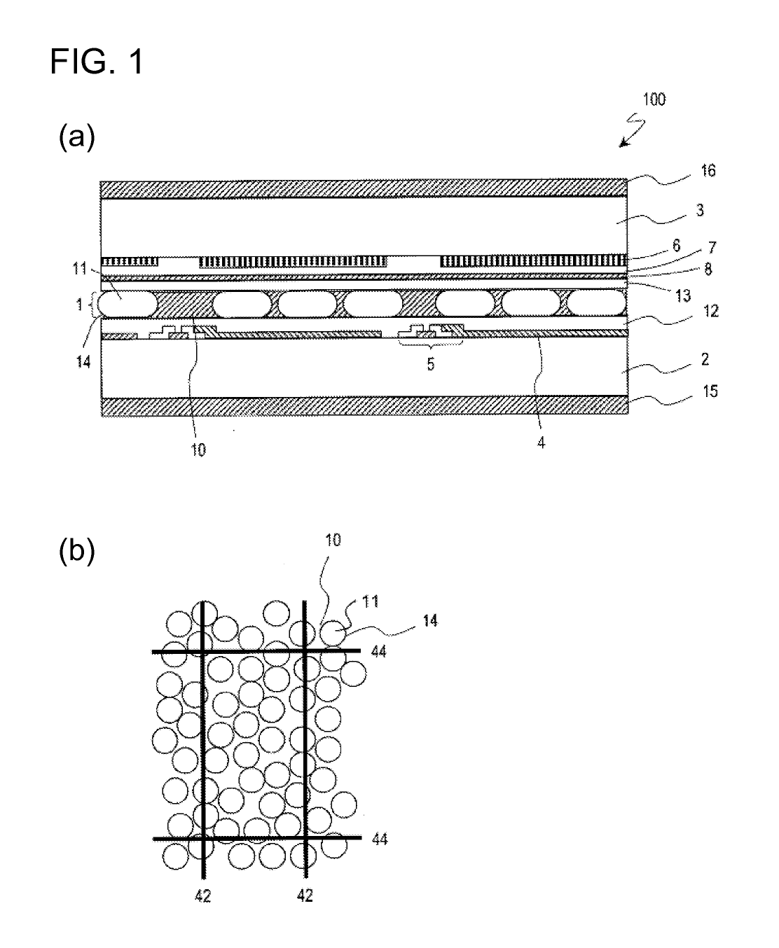

FIG. 1(a) is a cross-sectional diagram schematically showing a liquid crystal display device of a preferred embodiment of the present invention. FIG. 1(b) is a top view diagram schematically showing a portion of the liquid crystal layer in the liquid crystal display device shown in FIG. 1(a).

Turning first to FIG. 1(a), a liquid crystal display device 100 includes a front substrate 3; a rear substrate 2 positioned to face the front substrate 3; a liquid crystal layer 1 placed between these substrates 2 and 3; and polarizing plates 16 and 15 respectively placed on the front side of the front substrate 3 and the rear side of the rear substrate 2. The polarization plates 16 and 15 in the present preferred embodiment are linear polarization plates and are laid out in such a way that their axes of absorption are orthogonal to each other (cross-Nicol condition).

A plurality of switching devices (thin film transistors here) 5, a plurality of transparent pixel electrodes 4, and an alignment film 12 are formed in the order described on the surface of the rear substrate 2 on the side of the liquid crystal layer. The alignment film 12 in the present preferred embodiment is a horizontal alignment film and is in contact with the surface of the liquid crystal layer 1 on the rear side. The plurality of pixel electrodes 4 are laid out in isolation from each other and define the pixels, which make up the units of image display. In the present preferred embodiment, these pixel electrodes 4 are laid out in a matrix and are connected electrically to the respective drain electrodes (not shown in the figure) of the corresponding thin film transistors 5.

On the other hand, a color filter 6 for R (red color), G (green color), and B (blue color); a planarization film 7 for covering and planarizing the color filter 6; a transparent opposing electrode 8; and an alignment film 13 are formed in the order mentioned on the surface of the front side substrate 3 on the side of the liquid crystal layer in such a way as to correspond to the image pixels 4. The alignment film 13 is in contact with the surface of the liquid crystal layer 1 on the side of the front face. The alignment film 13 is a horizontal alignment film, similar to the alignment film 12. The alignment films 12 and 13 have been subjected to alignment treatments. Here, the alignment film 12 is rubbed in one direction, while the alignment film 13 is rubbed in a direction orthogonal to the rubbing direction on the alignment film 12.

The liquid crystal layer 1 is divided into a plurality of small chambers 14 by walls 10 containing a polymer. A liquid crystal region 11 is formed in each small chamber 14. In an example shown in the figure, a single liquid crystal region 11 is formed inside a single small chamber 14, but a plurality of the liquid crystal regions 11 may be formed in a single small chamber 14. In such an instance, the liquid crystal regions 11 inside the single small chamber 14 may be isolated by a polymer that does not make up the wall 10.

While the walls 10 and the alignment films 12 and 13 enclose a space that becomes the small chamber 14 in FIG. 1(a), the walls 10 alone may also enclose the space that becomes the small chamber 14. Or, as it will be later described, the small chamber 14 may not be completely enclosed by the walls 10 and the alignment films 12 and 13. Each of the liquid crystal regions 11 preferably is in contact with the alignment films 12 and 13 or positioned in the vicinity of the alignment films 12 and 13, so that the liquid crystal molecules in the liquid crystal regions 11 can be under the control of the alignment films 12 and 13.

As shown in FIG. 1(b), a plurality of source wiring lines 42 connected to the source electrodes and a plurality of gate wiring lines 44 connected to the gate electrodes of the thin film transistors are formed on the rear substrate. The plurality of small chambers 14 are laid out in each of the pixels surrounded by these wiring lines 42 and 44. The liquid crystal region 11 is formed in the small chamber 14. In the example shown in the drawing, the walls 10 defining the small chamber 14 are continuous.

The orientation states of the liquid crystal inside the liquid crystal region 11 according to the present preferred embodiment will be described next.

The orientations of the liquid crystal molecules located at the interfaces between the alignment films 12 and 13 and the liquid crystal layer 1 (called interface liquid crystal molecules) in the present preferred embodiment are controlled by the alignment films 12 and 13. Here the interface liquid crystal molecules refer to the liquid crystal molecules which make up an anchoring layer. Furthermore, the liquid crystal layer 1 includes at least two liquid crystal regions 11 having different interface liquid crystal molecule orientations.

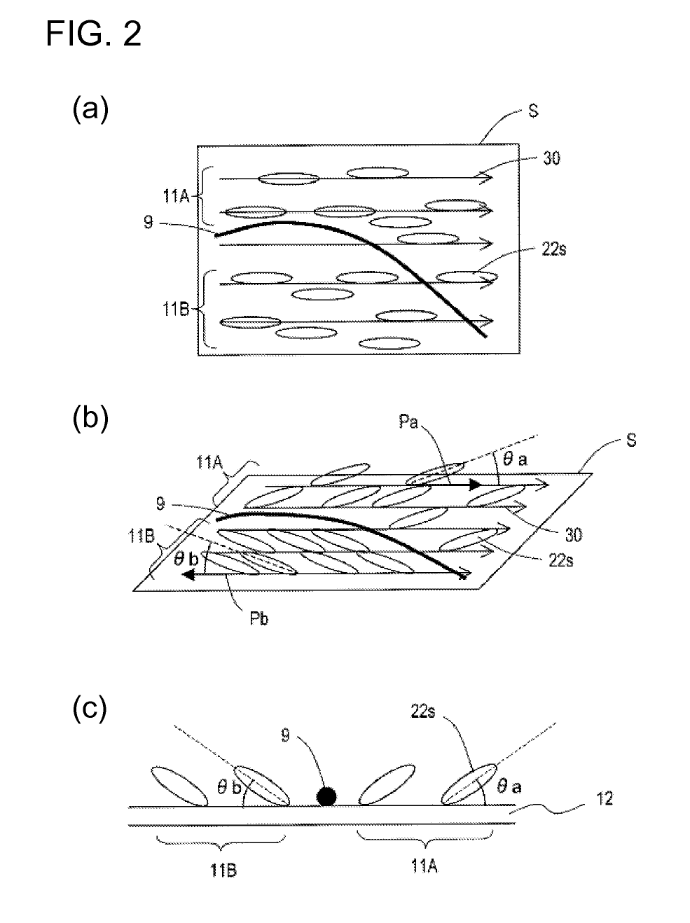

FIG. 2 shows a schematic of the orientation states of the interface liquid crystal molecules in two liquid crystal regions in the present preferred embodiment. FIG. 2(a) shows a plan view of the interface liquid crystal molecules 22s on the alignment film 12 (FIG. 1(a)), while FIG. 2(b) shows a perspective view, and FIG. 2(c) shows a cross-sectional view along the rubbing direction. Here, an example of the two liquid crystal regions 11A and 11B isolated by the polymer 9 will be described. In FIG. 2(a) and FIG. 2(b), in order to clearly illustrate the orientations of the interface liquid crystal molecules 22s, the interface liquid crystal molecules 22s are shown on an imaginary plane S on which arrows 30 indicate the rubbing direction.

As shown in FIG. 2(a) through FIG. 2(c), the in-plane orientations (director) of the interface liquid crystal molecules 22s are essentially parallel to the direction 30 (rubbing direction here) defined by the alignment treatment applied on the alignment film 12. On the other hand, the sizes and the directions of the tilt angles of the interface liquid crystal molecules 22s are different between the regions isolated by the polymer 9. In this example, the interface liquid crystal molecules 22s in the liquid crystal region 11A has a tilt angle θa in a direction Pa, which is the same as the rubbing direction 30, while the interface liquid crystal molecules 22s in the liquid crystal region 11B have a tilt angle θb in a direction Pb, which is opposite to that of the tilt angle θa. In the present specification, the tilt direction refers to the direction in which the liquid crystal molecules stand. In the example shown in the drawing, the tilt directions are the directions Pa and Pb of the tilt angles θa and θb (<90°) on the imaginary plane S.

Accordingly, the tilt directions Pa and Pb of the interface liquid crystal molecules 22s are different between the two liquid crystal regions 11A and 11B isolated by the polymer 9. While the example described here is for the interface liquid crystal molecules 22s on the alignment film 12, the orientations of the interface liquid crystal molecules on the alignment film 13 are similar.

Because two liquid crystal regions 11A and 11B having the interface liquid crystal molecules 22s with parallel in-plane orientations and mutually different tilt directions are present in the single pixel in the liquid crystal layer according to the present preferred embodiment, an effect similar to that of the orientation division is achieved. As a result, the view angle characteristics are improved.

The sizes of the tilt angles θa and θb in each of the liquid crystal regions may either be substantially the same or different between the liquid crystal regions 11A and 11B. Furthermore, when a plurality of the liquid crystal regions, all having the same interface liquid crystal molecule in-plane orientation and tilt direction, are present in the pixel, the sizes of the tilt angles θa, θb in these liquid crystal regions may be the same or different. Here, the presence of the plurality of liquid crystal regions having varying sizes of tilt angles further improves the view characteristics and is preferred. The sizes of the tilt angles θa and θb are determined not only by the types of alignment films and liquid crystal materials, but also by the types and amounts of polymer in the liquid crystal layer and the shape of the small chambers.

In the present preferred embodiment, only at least one each of the liquid crystal regions 11A and 11B needs to be present in the single pixel, and these liquid crystal regions 11A and 11B do not need to be adjacent to each other. However, substantially all of the liquid crystal regions in the pixel preferably are either liquid crystal region 11A or 11B, as described above, as this will effectively further improve the view angle characteristics.

As shown in FIG. 2, the polymer 9 or the wall including a polymer preferably is placed between the liquid crystal regions 11A and 11B according to the present preferred embodiment. More preferably, the liquid crystal regions 11A and 11B may be isolated by the polymer 9 or the wall including the polymer. “Isolated” here means that the polymer 9 or the wall is present between these liquid crystal regions 11A and 11B, and the polymer 9 or the wall defines the boundary between the liquid crystal regions 11A and 11B, and the polymer 9 or the wall does not need to be continuous. As a result, the liquid crystal orientation in each of the liquid crystal regions 11A and 11B becomes stable.

Furthermore, when the polymer 9 or the wall is present between the liquid crystal regions 11A and 11B, the formation of a disclination line, which causes discontinuous liquid crystal molecule orientations at the boundary between the liquid crystal regions 11A and 11B, is prevented. When there is a disclination, a region is created in the liquid crystal region 11, through which the light would not transmit for the white color display and would transmit for the black color display. As a result, the brightness for the white color display and the contrast may be adversely affected. Furthermore, the liquid crystal molecules would be less responsive to the drive in the vicinity of the disclination in the liquid crystal region 11, and, as a result, the response speed would go down. Therefore, when the polymer 9 or the wall prevents the formation of the disclination line, a reduction in the display contrast ratio and the response speed caused by the disclination can be prevented.

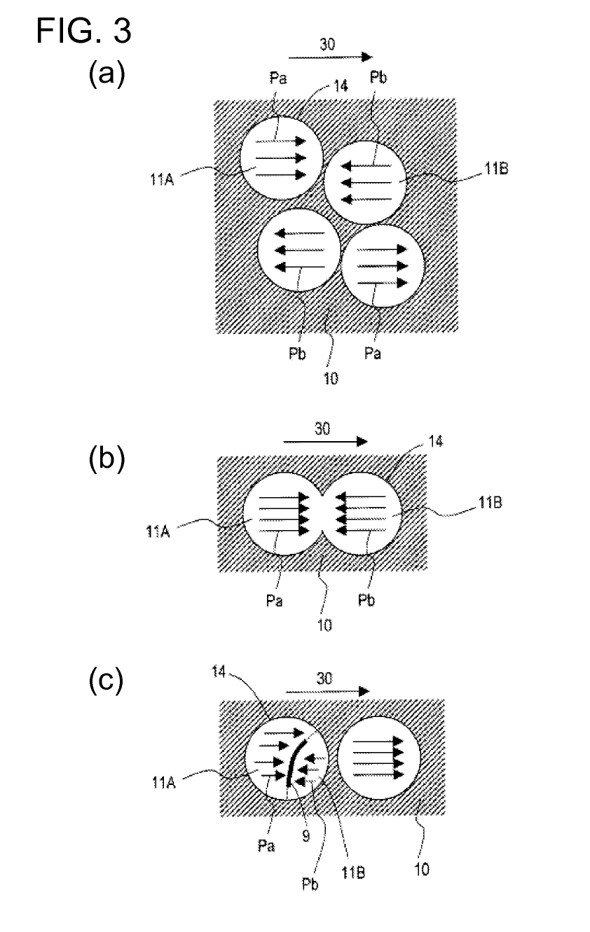

FIG. 3(a) through FIG. 3(c) show plan view schematics of the examples of the layouts of the liquid crystal regions 11A and 11B. As shown in FIG. 3(a), each of the liquid crystal regions 11A and 11B may be formed in the small chambers 14, which are completely surrounded by the walls 10. The orientations in the liquid crystal regions 11A and 11B can be thus stabilized more effectively. As shown in FIG. 3(b), the liquid crystal regions 11A and 11B may not be isolated by the walls 10 placed therebetween. Or, as shown in FIG. 3(c), a plurality of liquid crystal regions 11A and 11B may be formed inside a single small chamber 14. In such an instance, these liquid crystal regions 11A and 11B may be isolated by the polymer 9.

Turning again to FIG. 1, the liquid crystal region 11 according to the present preferred embodiment preferably is formed in such a way as to span across the thickness of the liquid crystal layer 1. More preferably, a plurality of the small chambers 14 are laid out in a single layer in the liquid crystal layer 1, and a single liquid crystal region 11 is formed in each of the small chambers 14. “The small chambers 14 laid out in a single layer” means that another small chamber 14 is not located between the small chamber 14 and the alignment film 12 or 13. With such a structure, the interface liquid crystal molecules on the side of the front substrate 3 is controlled by the alignment film 13, and the interface liquid crystal molecules on the side of the rear substrate 2 is securely controlled by the alignment film 12 in the liquid crystal region 11.

Because the rubbing directions on the alignment films 12 and 13 are orthogonal to each other in the present preferred embodiment, the liquid crystal molecules in each of the liquid crystal regions 11 are twisted by approximately 90° from a direction parallel to the rubbing direction on the alignment film 12 to a direction parallel to the rubbing direction on the alignment film 13, when a voltage is not applied on the liquid crystal layer 1. Here, as described with reference to FIG. 2, two respective orientations are present for the interface liquid crystal molecules on the side of the front substrate 3 and for the interface liquid crystal molecules on the side of the rear substrate 2, and their combinations yield a total of four different types of liquid crystal regions having different orientations.

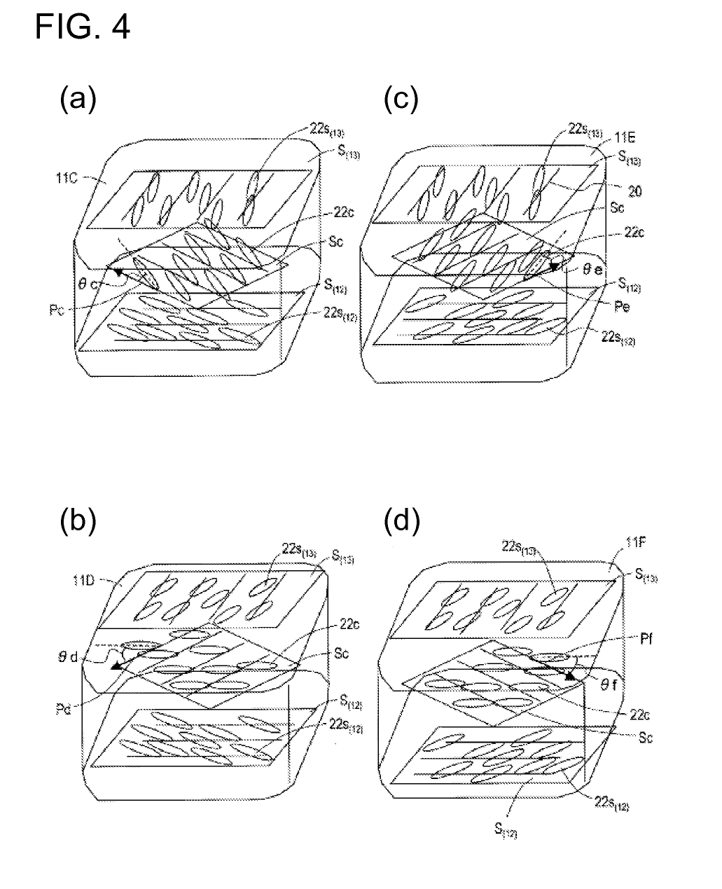

FIG. 4(a) through FIG. 4(d) are perspective view schematics showing examples of the orientation states in the aforementioned four types of liquid crystal regions. For the sake of illustration, in these figures, the interface liquid crystal molecules 22s₍₁₂₎ on the side of the alignment film 12 are shown on the imaginary plane S₍₁₂₎, which is parallel to the substrate, and the interface liquid crystal molecules 22s₍₁₃₎ on the side of the alignment film 13 are shown on the imaginary plane S₍₁₃₎, which is parallel to the substrate. Furthermore, the center liquid crystal molecules 22c, located at the center of the liquid crystal regions 11C through 11F, i.e., at the center of the liquid crystal layer 1, are shown to be on the imaginary plane Sc, which is parallel to the substrate. The straight lines on each of the imaginary planes show the directors on their respective imaginary planes.

As shown in the figures, the liquid crystal region 11C in FIG. 4(a) and the liquid crystal region 11D in FIG. 4(b) have the same tilt directions for the interface liquid crystal molecules 22s₍₁₂₎, but the tilt directions for the interface liquid crystal molecules 22s₍₁₃₎ are opposite to each other. Furthermore, in the liquid crystal region 11E shown in FIG. 4(c) and the liquid crystal region 11C, the tilt directions of the interface liquid crystal molecules 22s₍₁₂₎ are opposite to each other, but the tilt directions of the interface liquid crystal molecules 22s₍₁₃₎ are both the same. In the liquid crystal region 11F shown in FIG. 4(d) and the liquid crystal region 11C, the tilt directions of the interface liquid crystal molecules 22s₍₁₂₎ and the interface liquid crystal molecules 22s₍₁₃₎ are opposite to each other. As a result, the directions (tilt directions) Pc through Pf of the tilt angles θc through θf of the center liquid crystal molecules 22c on the imaginary plane Sc in the respective liquid crystal regions 11C through 11F are different from one another.

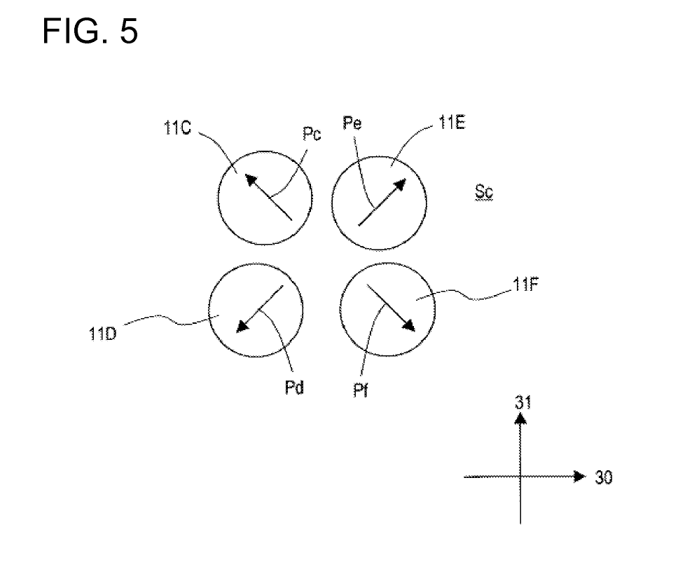

FIG. 5 is a drawing showing the tilt directions Pc through Pf of the center liquid crystal molecules 22c on the respective imaginary planes Sc in the liquid crystal regions 11C through 11F. Orientations 30 and 31, respectively, indicate the rubbing directions on the alignment films 12 and 13.

As can be understood from FIG. 4 and FIG. 5, while the in-plane orientations of the center liquid crystal molecules 22c in the liquid crystal regions 11C and 11F are parallel to each other, their tilt directions Pc and Pf are opposite to each other. While the in-plane orientations of the center liquid crystal molecules 22c in the liquid crystal regions 11D and 11E are parallel to each other, their tilt directions Pd and Pe are opposite to each other. The in-plane orientations of the center liquid crystal molecules 22c in the liquid crystal regions 11C and 11F are substantially orthogonal to the in-plane orientations of the center liquid crystal molecules 22c in the liquid crystal regions 11D and 11E. According to the present preferred embodiment, the presence of four types of liquid crystal regions 11C through 11F having different tilt directions Pc through Pf for the center liquid crystal molecules 22c in a single pixel is possible. As a result, dependence on the view angle (extreme angle) of the direction of observation is drastically reduced.

A detailed description will be provided next on the reason for the improved view angle dependence with the presence of a mixture of the liquid crystal regions 11C through 11F having different tilt directions for the center liquid crystal molecules 22c in a liquid crystal display device of the TN mode.

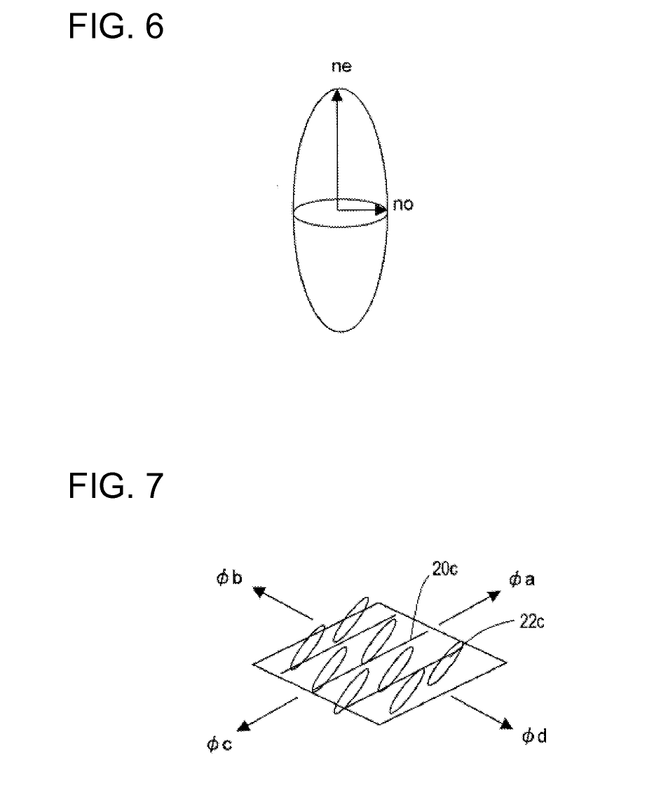

As shown in FIG. 6, the refractive index of the nematic liquid crystal may be schematically represented by a single-axis index ellipsoid. Here, “no” represents the ordinary refractive index, while “ne” represents the extraordinary refractive index. In a liquid crystal display device of the TN mode relying on such a nematic liquid crystal, the center liquid crystal molecules tend to stand in a specific direction with the intermediate gray scale display state. As shown in FIG. 7, for example, the center liquid crystal molecules stand up in one direction with respect to the in-plane orientation 20c. As a result, the refractive index anisotropy observed is different, when viewed from the direction offset from a direction normal to the display panel towards the φa direction, when viewed from the directions offset from a direction normal to the display panel towards the φb, φd directions, and when viewed from the direction offset from a direction normal to the display panel towards the φc direction. Specifically, ne is smaller when viewed from a direction off toward the φa direction, compared with when viewed from the direction normal to the display panel (direct front). ne is larger when viewed from the direction off toward the φc direction, compared with when viewed from the direct front. ne is at an intermediate level between these when viewed from the directions which are off toward the Φb and Φd directions. Accordingly, the display brightness varies, depending on the viewing directions, and the view angle dependence on the view direction is large.

On the other hand, as described with reference to FIG. 4, the observer sees an average of the transmissivity characteristics of the liquid crystal regions 11C through 11F, when a mixture of the four liquid crystal regions 11C through 11F having center liquid crystal molecules 22c with different tilt directions is present in a single pixel. As a result, the viewer sees the display with substantially the same brightness regardless of the viewing direction. In other words, the display contrast ratio dependence on the extreme angles does not change much with the direction of viewing.

In the present preferred embodiment, the polymer that does not make up the wall preferably is present on the alignment films 12 and 13. More preferably, at least a portion of the alignment films 12 and 13 may be covered by the polymer. Because the force of anchoring on the liquid crystal by the polymer is smaller, compared with the anchoring force on the liquid crystal by the alignment films 12 and 13, the presence of polymer between the alignment films 12 and 13 and the liquid crystal region 11 reduces the voltage required for changing the orientation of the interface liquid crystal molecules 22s. As a result, a display device that can be driven at an even lower voltage is realized.

The liquid crystal layer 1 of the present preferred embodiment can be formed using materials similar to those for the polymer dispersed liquid crystal (PDLC). For example, it is obtained by creating a solution mixture of nematic liquid crystal material (in other words, a low molecular weight liquid crystal component) and a photocurable resin (monomer and/or oligomer), placing it between transparent substrates, and polymerizing the photocurable resin. The dielectric anisotropy of the liquid crystal material in the liquid crystal layer preferably is positive. While the photocurable resin is not limited to a specific type, a UV curable resin preferably is used. The use of the UV curable resin eliminates a need to heat the aforementioned mixture for polymerization and can prevent an adverse effect on the other parts by heat. The monomer and oligomer can either be monofunctional or multifunctional.

Furthermore, as described above, the liquid crystal regions having different twist directions preferably are formed at substantially the same ratios in the present preferred embodiment. Therefore, chiral agents preferably are not added to the liquid crystal layer 1.

Alignment films subject to the alignment process and polarizing plates are generally not used in a liquid crystal display device using the PDLC (polymer dispersed liquid crystal). Because it is possible to switch the optical characteristics of the PDLC between a scattered state and a transmissive state by applying voltage on the liquid crystal layer, the use of the PDLC makes the display work without relying on the polarization plates and alignment films. On the other hand, the present preferred embodiment realizes a new orientation division mode using alignment films that have been subjected to the alignment treatments and polarization plates, while using materials similar to the PDLC.

While the alignment films 12 and 13 are not limited to a specific type, they preferably are alignment films capable of providing a pre-tilt angle of 1° or greater and 10° or smaller on the liquid crystal material used in the present preferred embodiment. If an alignment film that provides a larger pre-tilt angle is selected, the pre-tilt direction becomes the same as the rubbing direction in a large portion of the liquid crystal regions, and the ratio of the liquid crystal regions having a tilt direction opposite to the rubbing direction decreases. However, because the sizes of the tilt angles θa and θb of the interface liquid crystal molecules 22s in the present preferred embodiment are not determined solely by the types of the alignment films 12 and 13, as described earlier, the pre-tilt angles are not limited to the aforementioned range.

Next, a description of an example of a method of manufacturing the liquid crystal layer in the present preferred embodiment will be provided.

First, horizontal alignment films are coated on the surfaces of the two substrates, respectively. Next, an alignment treatment, such as a rubbing treatment, is applied on the surfaces of these alignment films. The directions defined by the alignment treatments on these substrates should be identical across the entire substrate surfaces. Therefore, there is no need to repeat multiple treatments by regions as in the case of masked rubbing, for example.

These substrates are positioned in such a way that the alignment films face each other, and the directions defined by the alignment treatments are mutually orthogonal, and are coupled together through spacers for ensuring a constant gap therebetween. Then, a liquid crystal mixture including the liquid crystal material and the polymer precursor is filled between these substrates (vacuum injection method).

Next, the polymer precursor in the liquid crystal mixture is polymerized by, for example, irradiation of light (UV ray) at a temperature at or above the phase transition temperature Tni of the liquid crystal mixture. As a result, the polymer precursor forms the polymer, and at the same time, the polymer and liquid crystal separate into different phases. The liquid crystal layer 1 is thus obtained. As shown in FIG. 1, the plurality of small chambers 14, isolated by the wall 10 including the polymer, are formed in the liquid crystal layer 1, and the liquid crystal region 11 (the liquid crystal region inside the small chamber is also called a liquid crystal droplet) is formed in each of the small chambers 14. These liquid crystal regions 11 randomly include the four liquid crystal regions 11C through 11F shown in FIG. 4.

Here, the aforementioned temperature at or above the phase transition temperature Tni can be any temperature at which at least a portion of the liquid crystal material in the aforementioned liquid crystal mixture turns into the istotropic phase and does not need to be the temperature at which the phase would be completely isotropic. Furthermore, the size of the small chamber 14 may be adjusted as needed according to the irradiation conditions (for example, irradiation intensity) of the light for polymerizing the polymer precursor.

While the vacuum injection method is used for forming the liquid crystal layer in the method described above, the ODF method may also be used instead.

The liquid crystal mixture used in the method described above preferably is a mixture of a UV curable resin and a liquid crystal composition. For example, a liquid crystal mixture, which has the nematic liquid crystal phase at room temperature, obtained by mixing a UV curable material and a liquid crystal at a 20:80 weight ratio and by adding a small quantity of a photo-polymerization activation agent may be used.

Furthermore, the material for the alignment films is not limited particularly, and known horizontal alignment films may be used. In order to form the small chambers 14 in such a way that the liquid crystal region 11 is in contact with the alignment films 12 and 13, however, the surface free energy of the alignment films 12 and 13 preferably is optimized. A preferred range for the surface free energy depends on the material used for the liquid crystal layer 1 and is, for example, 44 mJ/m² or more and 50 mJ/m² or less.

According to the method described above, a liquid crystal layer which is essentially uniform across the entire substrate surface can be formed, because it is not necessary to strictly control the temperature as in the method in Patent Document 1. Therefore, across-the-screen display variation can be suppressed. Furthermore, orientation division is realized without a complicated manufacturing process, such as the masked rubbing or the method of Patent Document 2. Furthermore, the present preferred embodiment achieves improved view angle characteristics over the conventional art, because the polymer 9 or the wall 10, made of a polymer, stabilizes the orientation in each region and suppresses the creation of the disclination line. Accordingly, stable manufacturing of the display device with superior view angle characteristics at high productivity is made possible with the aforementioned method.

The structure of the liquid crystal display device in the present preferred embodiment is not limited to the structure of the aforementioned liquid crystal display device 100. While the directions defined by the alignment films 12 and 13 (in-plane orientations) are mutually orthogonal in the liquid crystal display device 100, the angle formed by the in-plane orientations defined by the alignment films 12 and 13 is not limited to 90° and may be 70° or greater and less than 110°, for example, when viewed from a direction normal to the front substrate 3.

Furthermore, the present invention may also be applied to a display device of the HAN mode. In the HAN mode, a horizontal alignment film is formed on the surface of one of the substrates and subjected to the alignment treatment. A vertical alignment film is formed on the surface of the other substrate. As a result, the liquid crystal orientation transitions continuously from an essentially vertical orientation to an essentially horizontal orientation across the thickness of the liquid crystal layer when no voltage is applied. Because the tilt directions of the interface liquid crystal molecules on the alignment film, which has been subjected to the alignment treatment, can be made to vary among the liquid crystal regions even in the HAN mode, improvements in the view angle characteristics are possible.

### EMBODIMENTS 1 AND 2 AND COMPARISON EXAMPLE

Display panels according to the embodiments and the comparison example were manufactured, and their view angle and electro-optical characteristics were measured and evaluated. The methods and results will be described next.

(a) View Angle Measurements and Evaluation

### Embodiment 1

An embodiment of the liquid crystal display device according to the preferred embodiment will be described next.

Horizontal alignment films (RN-1251, a Nissan Chemical Industries, Ltd. product name) were coated on two substrates having electrodes, and a rubbing treatment was applied on these alignment films.

Next, these substrates were placed in such a way that the rubbing directions on the alignment films were orthogonal to each other, and were coupled together through spacers therebetween. A mixture of polymerizing monomer, an optical polymerization activation agent, and a positive liquid crystal (liquid crystal mixture) were injected into a gap between the coupled substrates. The temperature during the injection was set to a temperature (50° C., for example) at or above the phase transition temperature Tni (40° C., for example) between the liquid crystal phase and the isotropic phase of the liquid crystal mixture in order to prevent the polymerizing monomer and the positive liquid crystal from isolating during the injection process and causing a concentration nonuniformity across the display panel.

Next, the liquid crystal mixture between the substrates was irradiated with a UV ray passing through a filter that did not allow the light of 330 nm or less to transmit through. The temperature during the UV ray irradiation was set to a temperature (45° C., for example) at or above the phase transition temperature Tni between the liquid phase and the isotropic phase. Furthermore, the radiation intensity was set to 20 mW/cm² at 365 nm. As a result, the monomer in the liquid crystal mixture was polymerized to form walls, and the liquid crystal was formed into separate phases. As a result, liquid crystal regions were formed in small chambers (diameter: 5 to 10 μm) isolated by the walls.

After that, polarization plates were affixed on the respective surfaces on the outer sides of the substrates that have been coupled together. The polarization plates were positioned in such a way that their absorption axes are orthogonal to each other (cross-Nicol condition). This way, the display panel of Embodiment 1 was manufactured.

View angle measurements were taken on the display panel manufactured by the aforementioned method using a view angle measurement device (EZ Contrast: ELDIM Corporate product name).

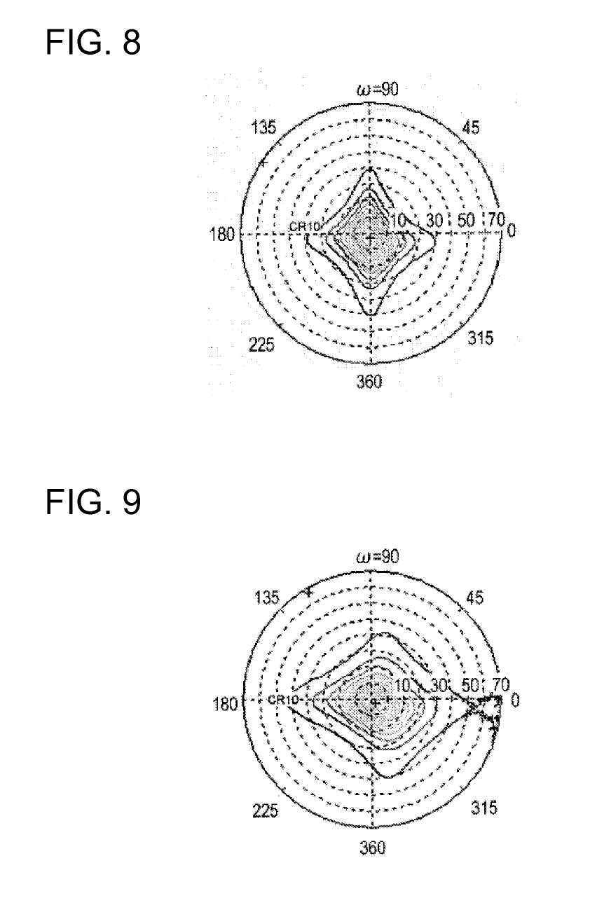

FIG. 8 shows the contrast contour curves obtained based on measurements of the brightness under a 0 V applied voltage (white color display) and under a 2.2 V applied voltage (a black color display). A contrast contour line is a line connecting the points representing the directions of observation at which the contrast ratio is the same, and the farther away from the center of the circle, the larger is the angle of observation (extreme angle) with respect to the normal direction of the display panel. Furthermore, the direction angle ω (0 to 360°) represents the direction angle ω of the observation direction across the surface. ω=0° and 180° are parallel to the direction of transmissivity axis of one of the polarization plates, and ω=90° and 270° are parallel to the direction of transmissivity axis of the other polarization plate.

The graph in FIG. 8 shows that the range of extreme angles at which a contrast ratio CR of 10 can be obtained does not change significantly as the observation direction changes. Therefore, it has been verified that a display with a small extreme angle dependence on the direction angle ω has been obtained. Here, the contrast ratio is relatively lower when the observation direction is 45° off of the transmissivity axis of the polarization plates, but this is due to the characteristics of the polarization plates.

### Embodiment 2

A display panel of Embodiment 2 was manufactured using the same method as Embodiment 1 except that different horizontal alignment films (Plx 1400: HD MicroSystems product name) were used.

View angle measurements were taken using the same method as Embodiment 1 for the display panel of Embodiment 2. FIG. 9 shows the contrast contour curves by observation directions based on the measurement results on the brightness under an applied voltage of 0 V (white color display) and an applied voltage of 2.4 V (black color display).

The graph in FIG. 9 shows that a display having a slightly larger dependence on the view angle direction but even wider view angles than the display panel of Embodiment 1 have been obtained.

### Comparison Example

A display panel of a comparison example was manufactured for the sake of comparison with the aforementioned Embodiments 1 and 2.

First, horizontal alignment films (RN-1251: Nissan Chemical Industries, Ltd. product name) were coated on the respective surfaces of two substrates having electrodes. Next, a rubbing treatment was applied to these alignment films.

Then the two substrates are coupled together in such a way that the rubbing directions of the alignment films are orthogonal to each other. A positive type liquid crystal is injected between the substrates that have been coupled together. The liquid crystal has a uniform orientation across the surface. Then polarization plates are affixed on the outer surfaces of the substrates that have been coupled together to achieve the cross-Nicol condition. The display panel of the comparison example was thus obtained.

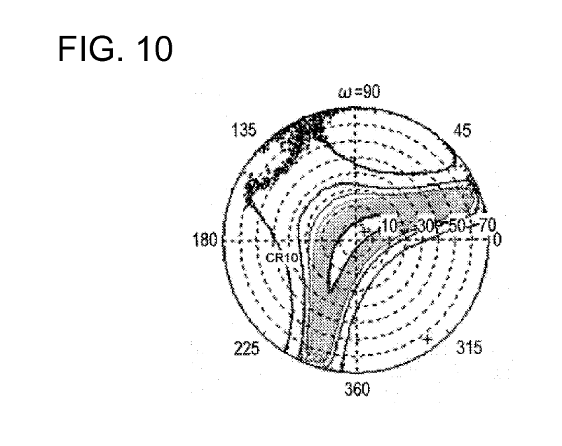

View angle measurements were taken using the method similar to the Embodiments 1 and 2 on the display panel of the comparison example. FIG. 10 shows the contrast contour curves by observation directions based on the measurement results on the brightness under an applied voltage of 0 V (white color display) and an applied voltage of 3 V (black color display). In this graph, the observation direction with a direction angle ω=135° corresponds to the direction φa described earlier with reference to FIG. 7.

The graph in FIG. 10 shows that the range of view angles (extreme angles) at which a contrast ratio CR of 10 can be obtained is large when observed from a direction angle ω of 135°, but the range of extreme angles at which the contrast ratio CR of 10 can be obtained is extremely small, when viewed from the opposite direction (ω=315°). Therefore, it has been verified that the view angle characteristics are non-uniform with respect to the observation directions and are dependent on the direction (tilt direction) in which the center liquid crystal molecules stand.

(b) Measurements and Evaluation of Electro-Optical Characteristics

Next, the electro-optical characteristics of the display panels of the Embodiments 1 and 2 and the comparison example were measured using an LCD evaluation device (LCD-5200: Ohtsuka Electronics Co., Ltd. product name).

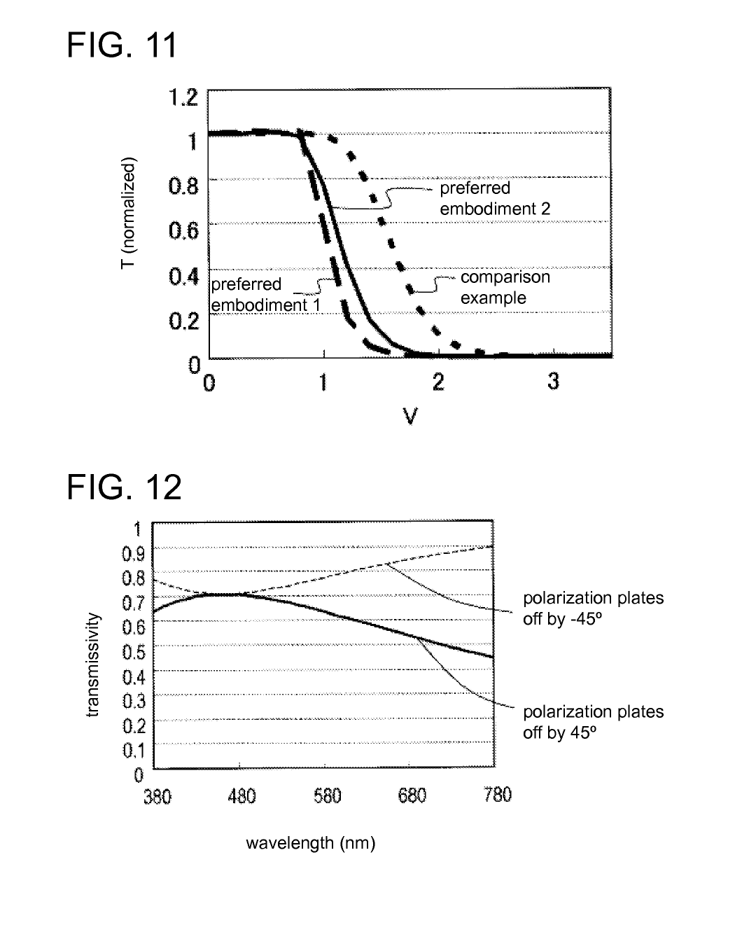

FIG. 11 is a graph showing the voltage-transmissivity (V-T) curves for the display panels of Embodiment 1, Embodiment 2, and the comparison example. For clearer comparison, the transmissivity T is shown using relative values such that the bright state is 1 and the dark state is 0 for each display panel.

These results show that the display panels of Embodiment 1 and Embodiment 2 were driven at voltages lower than the display panel of the comparison example. The reason for this is as follows. As mentioned earlier, the polymer or the walls made of the polymer in the liquid crystal layer covers at least a portion of the alignment film in the display panels of Embodiment 1 and Embodiment 2. Because the liquid crystal anchoring force by the polymer is smaller than the liquid crystal anchoring force by the alignment film, a smaller voltage is required for changing the orientation of the interface liquid crystal molecules when the alignment films are covered by the polymer as in Embodiments 1 and 2.

### Embodiment Example 3

Experiments were conducted to verify that a mixture of liquid crystal regions (liquid crystal droplets) having different liquid crystal twist orientations was present in the liquid crystal layer of preferred embodiments. The results will be described.

First, a liquid crystal layer was formed between the two substrates using a method similar to Embodiment 1 described above. Next, a polarization plate of 0° was affixed on the outer side of one of the substrates, and a polarization plate of the right 45° was affixed on the outer side of the other substrate. An experimental-use display cell was thus obtained.

In the experimental-use display cell, the polarization plate would be positioned at a −45° angle (in other words, in the 45° direction with respect to the liquid crystal twist orientation) with respect to the polarization plate in the cross-Nicol position if the liquid crystal region in the liquid crystal layer has a right hand twist. On the other hand, the polarization plate would be positioned at a 45° angle (in other words, in the 135° direction with respect to the direction of the liquid crystal twist) with respect to the polarization plate in a cross-Nicol position if the liquid crystal region has a left hand twist.

Here, a graph shown in FIG. 12 shows a transmissivity spectrum of a display device using a TN liquid crystal, which was calculated when the polarization plate is rotated by 45° and by −45° from the cross-Nicol position. As shown in this graph, the optical transmissivity is at the highest for the light of approximately 480 nm wavelength when the polarization plate is rotated by 45°, and the transmissivity is higher for the light having a wavelength greater than 480 nm when the polarization plate is rotated by −45°. As a result, a bluish color is observed for the 45° rotation, while a reddish color is observed for the −45° rotation.

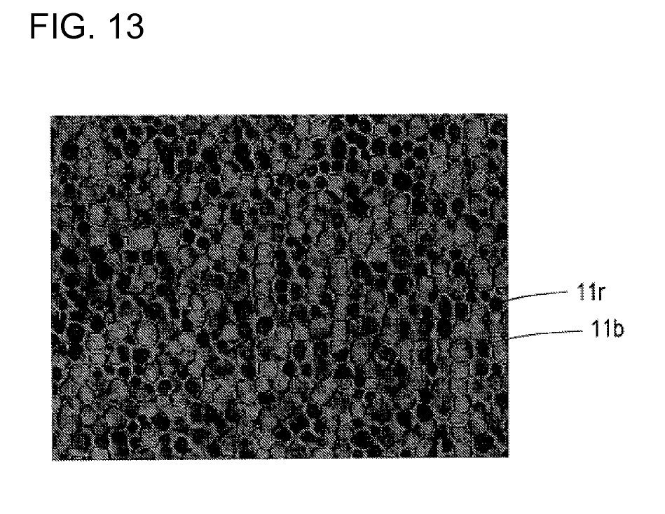

FIG. 13 shows an image of the display cell for the aforementioned experiment captured under a microscope. As shown in the figure, there is a mixture of a reddish region (liquid crystal droplet) 11r and a bluish region (liquid crystal droplets) 11b in the display cell for the experiment. Therefore, it has been verified that the right hand twisted liquid crystal droplets and left hand twisted liquid crystal droplets are mixed and distributed randomly in the liquid crystal layer of this experimental-use display cell.

Although a mixture of the liquid crystal regions having different twist directions has been verified here, it is difficult to verify through a direct observation a mixture of the liquid crystal regions having different standing directions. Nevertheless, it can be deduced, through comparisons among the contrast contour lines of the display cells of the aforementioned Embodiments 1 and 2 and the comparison example, that a mixture of liquid crystal regions having different standing directions are present in the liquid crystal layers of Embodiments 1 and 2.

Therefore, it has been verified through the view angle measurements and the observation using the microscope, as described above, that four types of liquid crystal regions, as shown in FIG. 4, are present in the liquid crystal layer of the present preferred embodiments.

### INDUSTRIAL APPLICABILITY

According to the present invention, a plurality of regions having different orientations can be formed in a pixel without using a complex process, such as masked rubbing. Accordingly, a liquid crystal display device offering a wide view angle can be provided using a simple method and at low cost.

The present invention can be applied to various liquid crystal display devices as well as to various electrical systems using the liquid crystal display device. The present invention is particularly suited for the transmissive type liquid crystal display device of the TN mode and the HAN mode using the horizontal orientation liquid crystal.

### DESCRIPTION OF REFERENCE CHARACTERS

1 liquid crystal layer

2 rear substrate

3 front substrate

4 pixel electrode

5 thin film transistor

6 color filter

7 planarization film

8 opposing electrode

9 polymer

10 wall

11, 11A through 11F liquid crystal regions

12, 13 alignment films

14 small chamber

15, 16 polarization plates

22s interface liquid crystal molecules

22c center liquid crystal molecules

30, 31 rubbing directions

42 source wiring lines

44 gate wiring lines

100 liquid crystal display device

1. A liquid crystal display device comprising:
a plurality of pixels;
a liquid crystal layer containing polymer;
a front substrate and a rear substrate holding said liquid crystal layer therebetween;
a pair of electrodes laid out with said liquid crystal layer sandwiched therebetween for applying a voltage on said liquid crystal layer;
polarizing plates placed on a front side of said front substrate and a rear side of said rear substrate, respectively; and
first and second alignment films formed, respectively, between said liquid crystal layer and said front substrate and between said liquid crystal layer and said rear substrate,
wherein an alignment treatment has been applied to at least one of said first and second alignment films,
wherein said liquid crystal layer includes in each of said pixels a plurality of liquid crystal regions and a wall including said polymer positioned between adjacent liquid crystal regions, and
wherein said plurality of liquid crystal regions includes two liquid crystal regions in which in-plane orientations of liquid crystal molecules in said two liquid crystal regions at an interface on the side of the alignment film to which said alignment treatment has been applied are in parallel with a direction defined by said alignment treatment, and tilt directions of the liquid crystal molecules in the two liquid crystal regions at said interface are mutually different.

2. The liquid crystal display device according to claim 1, wherein said liquid crystal layer includes a plurality of small chambers isolated by said wall, and said plurality of liquid crystal regions are respectively formed in one of said plurality of small chambers.

3. The liquid crystal display device according to claim 2, wherein said two liquid crystal regions are respectively formed in different small chambers.

4. The liquid crystal display device according to claim 1, wherein said two liquid crystal regions are formed in one small chamber and are isolated by said polymer.

5. The liquid crystal display device according to claim 1, wherein a portion of said polymer is present on the alignment film.

6. The liquid crystal display device according to claim 1, wherein said plurality of liquid crystal regions includes four liquid crystal regions having mutually different liquid crystal molecule tilt directions at a position corresponding with the center point along the thickness of said liquid crystal layer.

7. The liquid crystal display device according to claim 1, wherein the alignment treatment is applied to both of said first and second alignment films, and the direction defined by said first alignment film and the direction defined by said second alignment film form an angle of 70 degrees or greater and less than 110 degrees when viewed from a direction normal to said front substrate.

8. The liquid crystal display device according to claim 1, wherein the direction defined by said alignment treatment is identical across the entire said alignment film.

9. A method for manufacturing a liquid crystal display device having a plurality of liquid crystal regions, the method comprising:
preparing a front substrate having a surface on which a first alignment film is formed and a rear substrate having a surface on which a second orientation is formed; applying an alignment treatment on at least one of said first and second alignment films;
positioning said front substrate and said rear substrate in such a way that said first and second alignment films face each other, and injecting a liquid crystal material and a liquid crystal mixture containing one or both of monomer and oligomer between said positioned substrates; and
obtaining a liquid crystal layer by creating the liquid crystal phase in a process of polymerizing said monomer or oligomer or both at a temperature equal to or greater than a transition temperature Tni of said liquid crystal mixture,
wherein said liquid crystal layer includes a plurality of liquid crystal regions including two liquid crystal regions in which in-plane orientations of liquid crystal molecules in said two liquid crystal regions at an interface on the side of the alignment film on which said alignment treatment has been applied are in parallel with a direction defined by said alignment treatment, and the tilt directions of the liquid crystal molecules in said two liquid crystal regions at said interface are mutually different.
